(19) United States
(12) Patent Application Publication
(10) Pub. No.: US 2020/0238342 A1
(43) Pub. Date: Jul. 30, 2020

(54) CLEANING MACHINE

(71) Applicant: Hobot Technology Inc., Chupei City (TW)

(72) Inventor: Chi-Mou CHAO, Zhubei City (TW)

(21) Appl. No.: 16/736,022

(22) Filed: Jan. 7, 2020

(30) Foreign Application Priority Data
Jan. 25, 2019 (CN) 201910071831.0

(51) Int. Cl. B08B 3/02; B08B 1/04; B08B 3/12; A47L 1/02

(52) U.S. Cl. CPC B08B 3/024; A47L 1/02; B08B 3/12; B08B 1/04

(57) ABSTRACT

A cleaning machine for cleaning particles on a plate member includes a first cleaning device, a second cleaning device, a driving module, a spraying module and a control system. The first cleaning device is rotatable on the plate member. The second cleaning device is rotatable on the plate member. The driving module connected to the first cleaning device and the second cleaning device drives the first cleaning device and the second cleaning device to rotate at least one of the first cleaning device and the second cleaning device. The spraying module sprays liquid. The control system coupled to the spraying module and the driving module controls operations of the spraying module and the driving module. The spraying module of the cleaning machine of the invention has a wider spraying range, so that a wetted range on the plate member is wider.

### CROSS-REFERENCE TO RELATED APPLICATIONS

This application claims priority of No. CN201910071831.0 filed in China on 2019 Jan. 25 under 35 USC 119, the entire content of which is hereby incorporated by reference.

### BACKGROUND OF THE INVENTION

### Field of the Invention

The invention relates to a cleaning machine, and more particularly to a cleaning machine adapted for cleaning a surface.

### Description of the Related Art

Conventionally, the door and window at home are cleaned by opening the window or removing the window, and the door and window on the building are cleaned by a cleaning company and by installing a suspension frame on the external surface of the building, wherein a motor is utilized to control the suspension frame to move up and down so that the external door and window of the building can be brushed or cleaned by the water jet. However, the suspension frame tends to subject to wind and swing due to the unstable center of gravity. In order to avoid the dangerous accidents (e.g., when the staff slips, or when the cleaning appliance falls down to hurt a person or persons), which are caused by the excessively forced brushing on the door and window, only the slight flushing operations can be performed on the door and window so that the door and window cannot be completely cleaned.

With the rapid advancement of technology and the upgrading of human needs, that the manpower is replaced by the machine has become the trend of the times, and window cleaning robots for cleaning home doors and windows have become available in the modern society. When the window cleaning robot is wiping the glass, because the surface of the glass is usually covered with the deeper contamination, the wetted rag is needed to clean the contamination smoothly. FIG. 1 is a schematic view showing a conventional atomization cleaning robot. FIG. 1 shows an atomization cleaning robot disclosed in China Patent No. CN203244339U. Referring to FIG. 1, an atomization cleaning robot 20 for cleaning a surface of an object includes a body 10, a walking device 12, a cleaning part 15 and a spraying part 16. The body 10 is provided with an operation surface for wiping the surface of the object. The walking device 12 is mounted on the body 10. The cleaning part 15 is mounted on the operation surface and includes a rag. The spraying part 16 includes a liquid storage tank 161, an ultrasonic atomizer 162 and a nozzle 163 successively communicated together. The nozzle 163 is also mounted on the operation surface and disposed in front of the cleaning part 15. The atomization cleaning robot 20 adopts the cleaning part 15 and the spraying part 16, wherein the nozzle 163 of the spraying part 16 is disposed in front of the cleaning part 15, and the ultrasonic atomizer 162 is controlled by a controller 164 to perform the high-frequency resonance. The ultrasonic atomizer 162 atomizes the sprayed liquid to spray the atomized liquid onto the cleaning surface, and the liquid spraying amount is small and the sprayed liquid is very uniform.

However, the window cleaning robot needs to run back and forth multiple times to remove the deeper contamination, has the smaller spraying range, and still has the room for further improvements.

### BRIEF SUMMARY OF THE INVENTION

An objective of the invention is to provide a cleaning machine having a spraying module capable of spraying liquid onto a surface.

To achieve the above-identified objective, a cleaning machine for cleaning particles on a plate member according to an embodiment is provided. The cleaning machine includes a first cleaning device, a second cleaning device, a driving module, a spraying module and a control system. The first cleaning device is rotatable on the plate member. The second cleaning device is rotatable on the plate member. The driving module is connected to the first cleaning device and the second cleaning device, and drives the first cleaning device and the second cleaning device to rotate at least one of the first cleaning device and the second cleaning device. The spraying module sprays liquid. The control system is coupled to the spraying module and the driving module and controls operations of the spraying module and the driving module.

In one embodiment, the driving module includes a connection device connected between the first cleaning device and the second cleaning device, and the driving module drives the first cleaning device and the second cleaning device in a first period, so that the second cleaning device is rotated in a first rotation direction to generate a first torque, which swings the connection device in a second rotation direction reverse to the first rotation direction.

In one embodiment, the cleaning machine further includes a housing. The housing is used to accommodate the driving module and the control system, the housing is connected to the first cleaning device and the second cleaning device, and the housing is connected to the spraying module.

In one embodiment, the spraying module includes a liquid tank, a liquid drainage port and a liquid pumping unit. The liquid tank is used for storing the liquid, the liquid drainage port is used for spraying the liquid, and the liquid pumping unit is used for generating driving power to discharge the liquid from the liquid drainage port.

In one embodiment, the liquid pumping unit includes an ultrasonic vibrating piece, and the liquid drainage port is disposed on the ultrasonic vibrating piece.

In one embodiment, the spraying module further includes a liquid inlet port and a cover. The liquid inlet port is disposed on the liquid tank, the cover is configured to cover the liquid inlet port, and the cover is formed with a separation part.

In one embodiment, the liquid tank is defined with a storage space and a pressure relief hole, and the liquid inlet port is disposed on the liquid tank. The storage space is used for storing the liquid; the liquid inlet port communicates with the storage space; a protrusion of the cover can be plugged into the liquid inlet port to prevent the liquid from leaking out; and the pressure relief hole communicates with the storage space. In a process when the protrusion of the cover is plugged into the liquid inlet port, the storage space communicates with an external environment through the pressure relief hole. After the cover has been completely installed, the pressure relief hole is covered by the cover to prevent the liquid from leaking out of the pressure relief hole.

In one embodiment, the spraying module includes a column, and the liquid drainage port is disposed on the column and exposed from the housing. The housing is defined by a long-axis direction of the housing and a short-axis direction of the housing perpendicular to the long-axis direction of the housing, and an angle between a long-axis direction of the column of the projecting column and the short-axis direction of the housing ranges from 0 to 90 degrees.

In one embodiment, an angle between a direction of a normal of the liquid drainage port of the spraying module and a direction of a bottom surface parallel to the spraying module ranges from 0 to 90 degrees.

In one embodiment, the cleaning machine further includes a compressor module, wherein the first cleaning device and the plate member define a first space, the second cleaning device and the plate member define a second space, and the compressor module is communicated with the first space and the second space for pumping air from the first space and the second space, so that each of the first space and the second space forms a negative pressure, and the cleaning machine is sucked onto the plate member.

In one embodiment, the connection device is a machine base.

According to an embodiment, the spraying module can spray the liquid onto the surface of the plate member, so that the cleaning machine can wet the surface of the plate member while wiping the plate member, and can wipe the surface thereof to become cleaner. In one embodiment, the spraying module includes the ultrasonic wave vibration device and can spray the atomized cleaning liquid so that the tiny liquid drop can be condensed onto the surface more easily. In one embodiment, the projecting column of the spraying module projects beyond the top housing, and a predetermined distance is thus kept between the projecting column and the plate member. Therefore, compared with the prior art, the spraying module has a wider spraying range, so that a wetted range on the plate member is wider.

### BRIEF DESCRIPTION OF THE SEVERAL VIEWS OF THE DRAWINGS

The following drawings are only intended to illustrate and explain the present invention without limiting the scope of the invention.

FIG. 1 is a schematic view showing a conventional atomization cleaning robot.

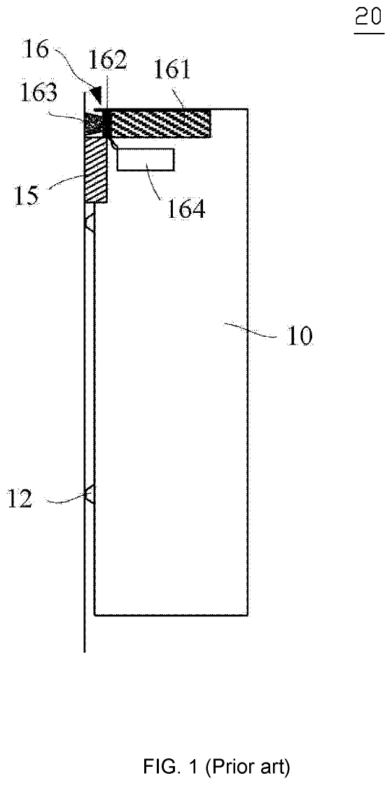

FIG. 2 is an exploded view showing a cleaning machine according to an embodiment.

FIG. 3A is a top view showing a cleaning machine according to an embodiment.

FIG. 3B is a side view showing a cleaning machine according to an embodiment.

FIG. 4 is an exploded view showing a driving module according to an embodiment.

FIG. 5 is an exploded view showing a compressor module according to an embodiment.

FIG. 6 is an exploded view showing a spraying module according to an embodiment.

### DETAILED DESCRIPTION OF THE INVENTION

In order to provide clearer understanding of the technical solutions, purposes and effects of the present invention, the embodiments of the present invention will be described in conjunction with the accompanying drawings.

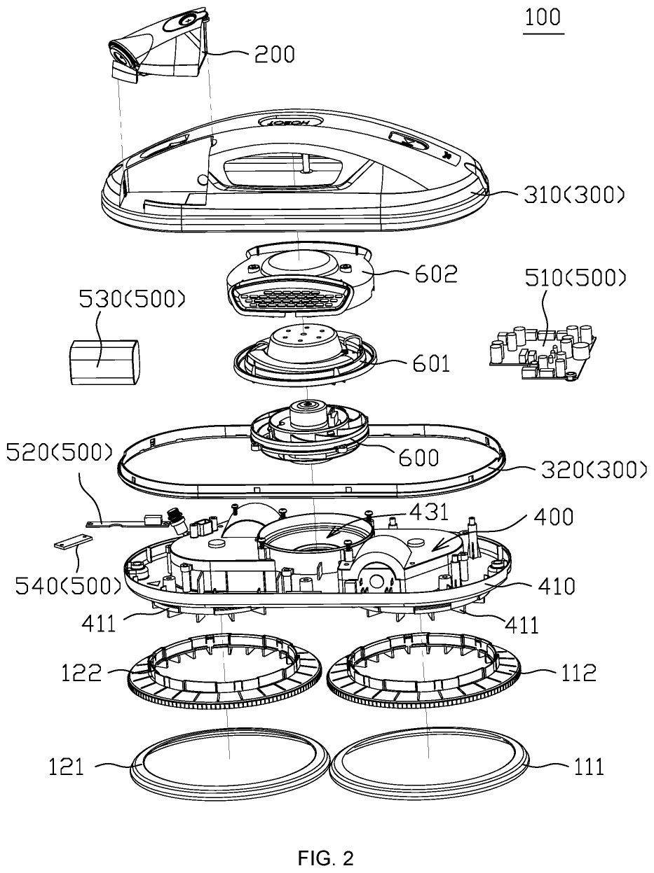

FIG. 2 is an exploded view showing a cleaning machine according to an embodiment. Referring to FIG. 2, a cleaning machine 100 for cleaning particles on a plate member in one embodiment includes a first cleaning device 110, a second cleaning device 120, a driving module 400, a spraying module 200 and a control system 500.

The first cleaning device 110 is rotatable on the plate member, and the second cleaning device 120 is rotatable on the plate member. The first cleaning device 110 includes a cleaning ring 112, and a cleaning cloth 111 is disposed or sleeved on a bottom surface of the cleaning ring 112. The second cleaning device 120 includes a cleaning ring 122, and a cleaning cloth 121 is disposed or sleeved on the bottom surface of the cleaning ring 122. The driving module 400 connected to the first cleaning device 110 and the second cleaning device 120 drives the first cleaning device 110 and the second cleaning device 120 to rotate at least one of the first cleaning device 110 and the second cleaning device 120. More specifically, the driving module 400 includes a connection device 410. The connection device 410 is connected between the first cleaning device 110 and the second cleaning device 120. The driving module 400 drives the first cleaning device 110 and the second cleaning device 120, such that the second cleaning device 120 is rotated in a first rotation direction in a first period to generate a first torque on the connection device 410 of the driving module 400, wherein the first torque swings the connection device 410 in a second rotation direction reverse to the first rotation direction.

The spraying module 200 sprays liquid onto the plate member to wet the cleaning cloth 111 and the cleaning cloth 121, so that the contamination on the plate member can be removed more easily. The control system 500 coupled to the spraying module 200 and the driving module 400 controls operations of the spraying module 200 and the driving module 400. The control system 500 includes a main circuit board 510, a sub-circuit board 520, a pneumatic circuit board 540 and a battery 530 electrically connected together. At least one chip and circuit capable of controlling various operations of the spraying module 200 and the driving module 400 are formed on the main circuit board 510 and the sub-circuit board 520, and the battery 530 is used to provide electric power for performing the operations. The pneumatic circuit board 540 is used to sense and control negative pressure states of a first space and a second space.

The cleaning machine 100 further includes a housing 300. The housing 300 is used to accommodate the driving module 400 and the control system 500, the housing 300 is connected to the first cleaning device 110 and the second cleaning device 120 through the connection device 410 of the driving module 400, and the housing 300 is connected to the spraying module 200. The housing 300 includes a top housing 310 and an edge trim 320. The edge trim 320 is located between the top housing 310 and the connection device 410, and the top housing 310 and the connection device 410 define an accommodating space for accommodating the spraying module 200, the driving module 400 and the control system 500.

In one embodiment, the cleaning machine 100 also includes a compressor module 600. The first cleaning device 110 and the plate member can define a first space, and the second cleaning device 120 and the plate member can define a second space. The compressor module 600 is located in a pump accommodating space 431 defined by the connection device 410, and the compressor module 600 is communicated with the first space and the second space, and pumps air from the first space and the second space, so that each of the first space and the second space forms a negative pressure, and the cleaning machine 100 is sucked onto the plate member. In one embodiment, the cleaning machine 100 also includes a silencer cover 601 and a handle set 602. Both the silencer cover 601 and the handle set 602 are located within the accommodating space defined between the top housing 310 and the connection device 410. The silencer cover 601 for reducing the noise generated by the compressor module 600 covers the compressor module 600, and the handle set 602 is located between the silencer cover 601 and the top housing 310.

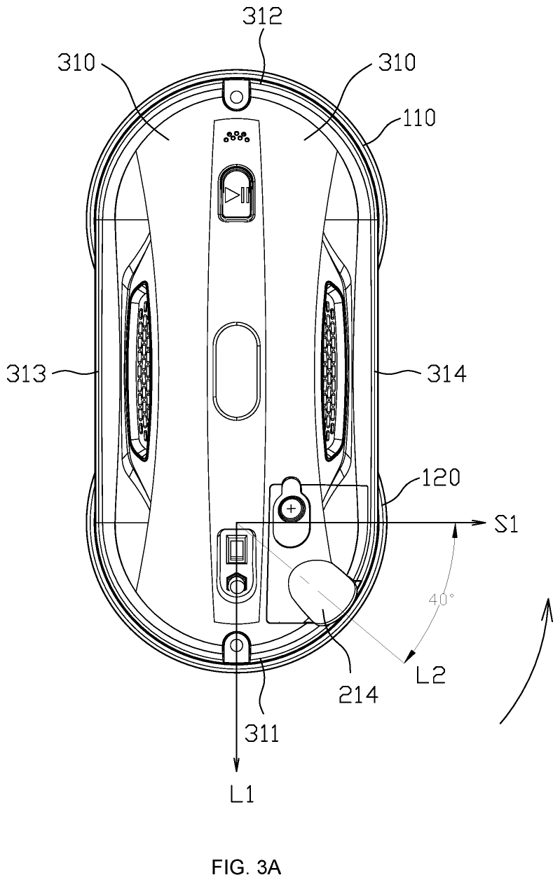

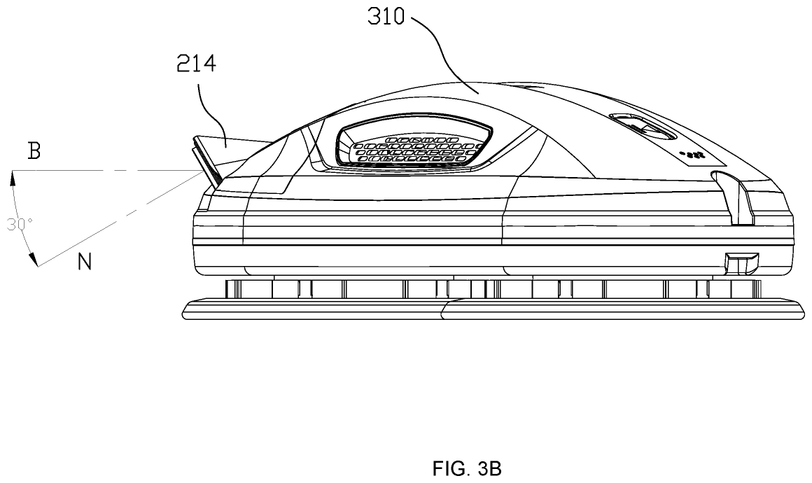

FIG. 3A is a top view showing a cleaning machine according to an embodiment. As shown in FIG. 3A, two ends of the top housing 310 of the housing 300 are formed with a first curve 311 and a second curve 312, and the middle portion of the housing 300 is formed with a first connection cable 313 and a second connection cable 314 opposite to each other. Preferably, the first curve 311 and the second curve 312 are respectively semicircles with openings opposite to each other, and are connected to the first connection cable 313 and the second connection cable 314, so that the housing 300 forms an approximately elliptical shape. In one embodiment, the spraying module 200 is disposed on one end of the two ends of the housing 300. In this embodiment, the spraying module 200 is disposed on the first curve 311 of the housing 300.

In one embodiment, the spraying module 200 includes a column, and a liquid drainage port 250 is disposed on the column and is exposed to outside from the housing 300. In this embodiment, the column is a projecting column 214. Specifically, the spraying module 200 includes the projecting column 214, the projecting column 214 protrudes from an outer surface of the housing 300, and the liquid drainage port 250 is disposed on the projecting column 214 and is exposed to outside from the housing 300. The housing 300 is defined by a long axis direction L1 and a short axis direction S1 perpendicular to the long axis direction L1. In one embodiment, an angle between a long axis direction L2 of the projecting column 214 and the short axis direction S1 of the housing 300 may range from 0 to 90 degrees, preferably from 20 to 70 degrees, and more preferably from 30 to 50 degrees. In this embodiment, the angle between the long axis direction L2 of the projecting column 214 and the short axis direction S1 of the housing 300 is equal to 40 degrees.

In one embodiment, as shown in FIG. 3A, after the spraying module 200 has sprayed, the first cleaning device 110 does not rotate or slightly rotates, and the second cleaning device 120 rotates in a clockwise direction to generate the first torque on the connection device 410 of the driving module 400, and the first torque swings the connection device 410 in a counterclockwise direction by taking the first cleaning device 110 as a swing fulcrum. The spraying direction of the spraying module 200 is substantially directed to the lower right direction and contains a rightward vector (i.e., it contains a vector of the swing path of the second cleaning device 120). So, in the process when the connection device 410 swings in the counterclockwise direction, a larger amount of liquid mist can fall on the swing path of the second cleaning device 120. In one embodiment, at least one portion of the spraying period of the spraying module 200 overlaps with the swing period of the second cleaning device 120. In one embodiment, the second cleaning device 120 starts to swing only after the spraying period of the spraying module 200.

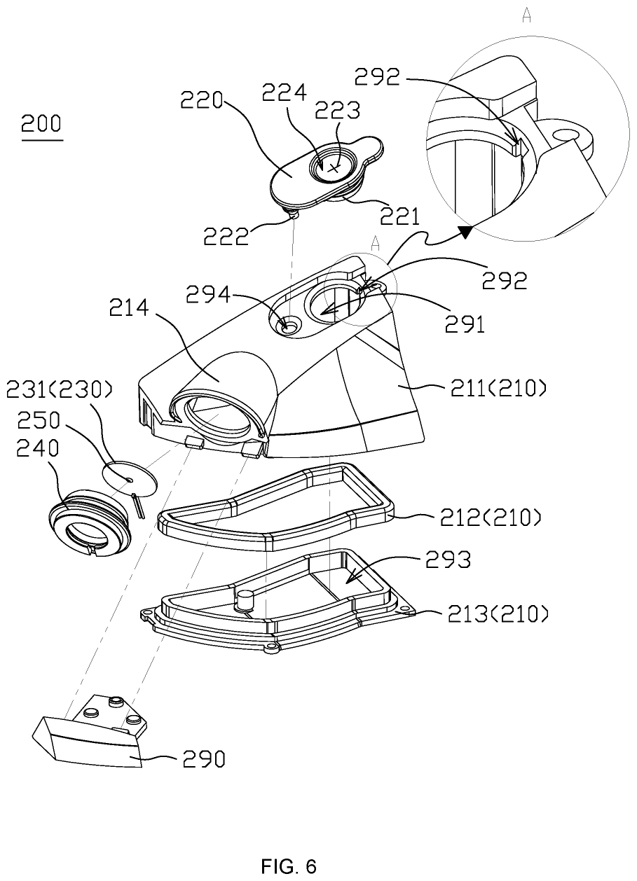

FIG. 3B is a side view showing a cleaning machine according to an embodiment. As shown in one embodiment of FIG. 3B, an angle between a direction of normal N of the liquid drainage port 250 (as shown in the following FIG. 6) of the spraying module 200 and a direction B parallel to a bottom surface (or a surface of the plate member) of the spraying module 200 may range from 0 to 90 degrees and preferably from 20 to 50 degrees. More preferably, in this embodiment, the angle between the direction of the normal N of the liquid drainage port 250 and the direction B parallel to the bottom surface (or the surface of the plate member) of the spraying module 200 is equal to 30 degrees.

The spraying module 200 may spray the liquid onto the surface of the plate member, so that the cleaning machine 100 can wet the surface of the plate member while wiping the plate member and can wipe the surface of the plate member to become cleaner. In one embodiment, the spraying module 200 includes an ultrasonic wave vibration device which can spray the atomized cleaning liquid, so that the tiny liquid drop can be condensed onto the surface more easily. According to an embodiment, the cleaning machine 100 can spray the atomized liquid onto the plate member while wiping the plate member, so that the plate member can be infiltrated, thereby wiping the plate member to become cleaner. In this embodiment, the projecting column 214 of the spraying module 200 protrudes from the top housing 310, and a predetermined distance is thus kept between the projecting column 214 and the plate member. Therefore, compared with the prior art, the spraying module 200 has a wider spraying range, so that a wetted range on the plate member is wider.

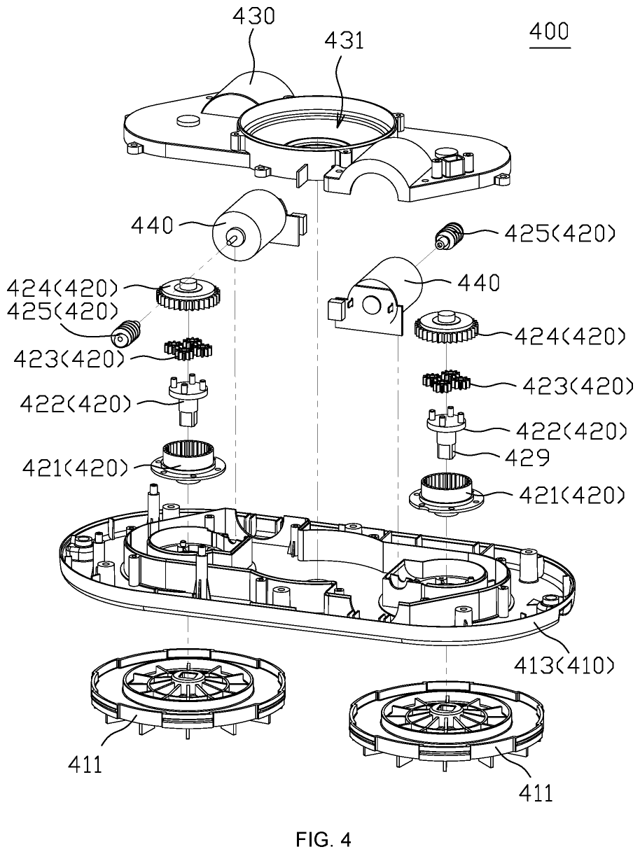

FIG. 4 is an exploded view showing a driving module according to an embodiment. As shown in FIG. 4, the driving module 400 includes a connection device 410, two transmission devices 420, two motors 440, two cleaning wheels 411 and an air guide cover 430. In this embodiment, the connection device 410 may be a machine base 413. In other embodiments, the connection device 410 may also be a connection rod. In this embodiment, because the machine base 413 is directly taken as the connection device 410, the provision of the connection rod can be omitted. An exhaust space is defined between the machine base 413 and the air guide cover 430, and the two transmission devices 420 and the two motors 440 are disposed between the machine base 413 and the air guide cover 430. The motors 440 are respectively connected to the cleaning wheels 411 through the transmission devices 420, thereby driving the cleaning wheels 411 to rotate. In one embodiment, each of the transmission devices 420 includes a gear fixing wheel 421, a spindle 422, multiple gears 423, a worm wheel 424 and a worm 425; the motor 440 is connected to the worm 425 and drives the worm 425 to rotate, the long axis direction of the worm 425 is parallel to the direction of the bottom surface of the cleaning machine 100, the worm 425 drives the worm wheel 424 to rotate and change the rotation direction, and the rotating axis of the worm wheel 424 is perpendicular to the bottom surface of the cleaning machine 100. The gears 423 are connected to the worm wheels 424 and disposed inside the gear fixing wheels 421, the gears 423 are fit with or sleeved at multiple support shafts projecting from the top side of the spindle 422, and the cleaning wheels 411 are fit with or sleeved at rotation shafts 429 projecting from the bottom side of the spindle 422.

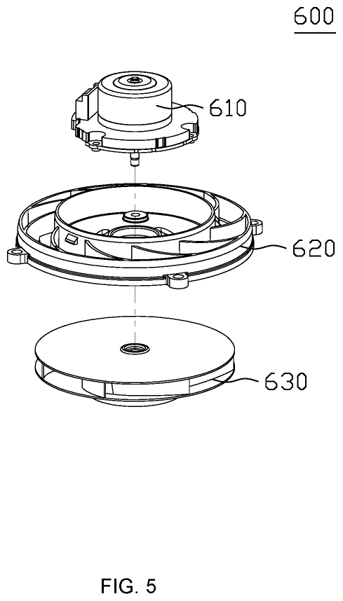

FIG. 5 is an exploded view showing a compressor module according to an embodiment. As shown in FIG. 5, the compressor module 600 includes a compressor motor 610, a compressor seat 620 and an impeller 630. The compressor motor 610 and the impeller 630 are respectively mounted on the compressor seat 620, and the compressor motor 610 drives the impeller 630 to rotate and pump the air from the first space and the second space.

FIG. 6 is an exploded view showing a spraying module according to an embodiment. The spraying module 200 includes a liquid tank 210, a cover 220, a liquid pumping unit 230 and a sealing rubber ring 240. The liquid tank 210 is used for storing the liquid. In one embodiment, the liquid tank 210 includes a liquid tank case 211, a leak-proof rubber strip 212 and a liquid tank lower cover 213. The leak-proof rubber strip 212 is interposed between the liquid tank case 211 and the liquid tank lower cover 213, and a space for storing the liquid is defined by the liquid tank case 211 and the liquid tank lower cover 213 to keep water tightness between the liquid tank case 211 and the liquid tank lower cover 213. In one embodiment, the liquid tank case 211 and the liquid tank lower cover 213 are constituted by a hard plastic material, and the leak-proof rubber strip 212 is constituted by a resilient material. In one embodiment, the leak-proof rubber strip 212 is constituted by a silica gel. In one embodiment, the liquid tank case 211 of the liquid tank 210 defines a liquid inlet port 291, a storage space 293 and a pressure relief hole 292. The liquid inlet port 291 is formed on a top of the liquid tank 210 and is used for injecting of the cleaning liquid into the liquid tank 210. The cover 220 is disposed in the liquid inlet port 291. The storage space 293 is used to store the liquid, and the liquid inlet port 291 communicates with the storage space 293. The cover 220 is disposed on the upper surface of the outside of the liquid tank. A protrusion 221 of the cover 220 is plugged into the liquid inlet port 291 to prevent the liquid from leaking out. The pressure relief hole 292 communicates with the storage space 293. In a process when the protrusion 221 of the cover 220 is plugged into the liquid inlet port 291, the storage space 293 communicates with an external environment through the pressure relief hole 292. After the cover 220 has been completely installed, the pressure relief hole 292 is covered by the cover 220 to prevent the liquid from leaking out of the pressure relief hole 292. In one embodiment, the cover 220 further includes a fixing column 222, and the liquid tank case 211 of the liquid tank 210 is further defined with a fixing hole 294. When the cover 220 is installed, the fixing column 222 can be firstly plugged into the fixing hole 294.

The spraying module 200 further includes the liquid drainage port 250 for spraying liquid. The cover 220 is defined with a depression 224, and a separation part 223 is formed on the depression 224. The separation part 223 passes through the thickness of the cover 220. In a closed state, the separation part 223 has a degree of closure to prevent leakage of the cleaning fluid, and thus the cleaning liquid cannot leak from the separation part 223. When the pressure of the storage space 293 is too high, the gas can be discharged from the separation part 223, thereby preventing the liquid from leaking from the liquid drainage port 250 during the non-spraying operation. In one embodiment, the cover 220 is made of a resilient material (such as a silica gel), so that the liquid tank 210 may have better sealing property, and may be opened by bending the cover 220. Therefore, when the cover 220 is not opened, the cleaning liquid will not leak from the liquid inlet port 291. The separation part 223 is formed with a split hole or crack, which may be disposed in a central area of the depression 224. In one embodiment, the split hole or crack may have a slit shape, a cruciform shape or other shapes. The split hole or crack passes through the cover 220, and its gap is very small, so the cleaning liquid can not pass therethrough, and thus the cleaning liquid cannot leak from the separation part 223. The liquid tank case 211 balances the internal pressure of the liquid tank 210 through the split hole or crack.

More specifically, because the inner space of the liquid tank 210 is almost full of the cleaning liquid, the liquid drainage port 250 outputs the water via the liquid pumping unit 230. Because the internal and external pressures of the liquid tank 210 are balanced, the split hole or crack is in a closed state. When the cleaning machine 100 continues to operate and spray the cleaning liquid, a water level of the liquid tank 210 continuously decreases. However, because the cover 220 seals the liquid inlet port 291, the excess container space in the liquid tank 210 approaches a vacuum state and a negative pressure is thus generated. If the negative pressure cannot be released, then the liquid pumping unit 230 cannot smoothly push the remaining cleaning liquid out of the liquid drainage port 250. According to the configurations that the depression 224 is thinner than the portions at other positions of the cover 220 and that the split hole or crack is located at the thinnest position of the depression 224, when the liquid tank 210 generates the negative pressure, the atmosphere pressure naturally pushes the depression 224 down to the liquid tank 210, and the aperture or interspace at the position of the split hole or crack will become larger. At this time, the air is naturally introduced into the liquid tank 210 until the internal and external pressures of the liquid tank 210 are almost balanced. The resilience of the depression 224 itself pulls it back, and the interspace of the split hole or crack is reduced and returned to the original closed state. With this design, the liquid pumping unit 230 needs not to operate at the high power, and can still maintain the drainage process smoothly with the desired output efficiency.

The sealing rubber ring 240 is used to fill the interspace between the liquid pumping unit 230 and the liquid tank case 211. In one embodiment, the sealing rubber ring 240 surrounds the liquid pumping unit 230. In one embodiment, the sealing rubber ring 240 is constituted by the silica gel. In one embodiment, the liquid drainage port 250 is disposed on the liquid pumping unit 230. The liquid pumping unit 230 is used to push the cleaning liquid out of the liquid tank 210 via the liquid drainage port 250 to perform the spraying operation. The liquid pumping unit 230 includes an ultrasonic vibrating piece 231. The sealing rubber ring 240 is located at an opening defined by the projecting column 214, and surrounds the ultrasonic vibrating piece 231, thereby fixing the ultrasonic vibrating piece 231 onto the projecting column 214. In one embodiment, the liquid drainage port 250 is disposed on the ultrasonic vibrating piece 231. When the liquid tank 210 is filled with the cleaning liquid, no leakage occurs even if the liquid drainage port 250 is not plugged with another cover because the aperture of the liquid drainage part is very small. The vibration source generated by the vibration sheet of the ultrasonic vibrating piece 231 pushes the cleaning liquid in a the direction toward the liquid tank 210, so that the cleaning liquid is pushed out of the liquid drainage port 250 and is sprayed outward. In one embodiment, the ultrasonic vibrating piece 231 may output a single frequency vibration wave through the vibration sheet, wherein the frequency exceeds at least 5K Hertz. In one embodiment, the ultrasound waves outputted from the ultrasonic vibrating piece 231 can cover multiple frequencies, and are constituted by multiple single frequency ultrasound waves. Through the liquid pushing operation performed by the very thin ultrasonic vibrating piece 231, the ultrasonic vibrating piece 231 having a relatively small volume can produce the required spraying distance (e.g., at least 3 cm), and is thus very suitable for the spraying module of a cleaning robot.

In one embodiment, the spraying module 200 also includes a liquid tank protection cover 290. The liquid tank protection cover 290 is disposed below the projecting column 214, and is fixed onto the top housing 310 of the cleaning machine 100 to protect the spraying module 200. In one embodiment, the liquid tank protection cover 290 is used to tightly fasten the liquid pumping unit 230 to the side surface of the liquid tank case 211 along with the sealing rubber ring 240, so as to enhance the water tightness of the liquid tank 210 around the liquid tank protection cover 290.

According to an embodiment, the spraying module 200 can spray the liquid onto the surface of the plate member, so that the cleaning machine 100 can wet the surface of the plate member while wiping the plate member, and can wipe the surface thereof to become cleaner. This wet mode can clean an oil stain or a sticking stain more effectively, and can provide the better cleaning effect than that of the dry mode. In the wet mode, most areas of the cleaning cloth 111 and the cleaning cloth 121 are inevitably wetted by the cleaning liquid on the plate member in the wipe process. In one embodiment, the spraying module 200 includes the ultrasonic wave vibration device and can spray the atomized cleaning liquid so that the tiny liquid drop can be condensed onto the surface more easily. In one embodiment, the projecting column 214 of the spraying module 200 projects beyond the top housing 310, and a predetermined distance is thus kept between the projecting column 214 and the plate member. Therefore, compared with the prior art, the spraying module 200 has a wider spraying range, so that a wetted range on the plate member is wider.

1. A cleaning machine for cleaning particles on a plate member, the cleaning machine comprising:
a first cleaning device rotatable on the plate member;
a second cleaning device rotatable on the plate member;
a driving module, connected to the first cleaning device and the second cleaning device, and used for driving the first cleaning device and the second cleaning device to rotate at least one of the first cleaning device and the second cleaning device;
a spraying module for spraying liquid; and
a control system, coupled to the spraying module and the driving module, and used for controlling operations of the spraying module and the driving module.

2. The cleaning machine according to claim 1, wherein:
the driving module comprises a connection device connected between the first cleaning device and the second cleaning device,
the driving module drives the first cleaning device and the second cleaning device in a first period, so that the second cleaning device is rotated in a first rotation direction to generate a first torque,
the first torque swings the connection device in a second rotation direction oppose to the first rotation direction.

3. The cleaning machine according to claim 1, further comprising a housing for accommodating the driving module and the control system, wherein the housing is connected to the first cleaning device and the second cleaning device, and the housing is connected to the spraying module.

4. The cleaning machine according to claim 3, wherein the spraying module comprises:
a liquid tank for storing the liquid;
a liquid drainage port for spraying the liquid; and
a liquid pumping unit for generating driving power to discharge the liquid from the liquid drainage port.

5. The cleaning machine according to claim 4, wherein an angle between a direction of a normal of the liquid drainage port of the spraying module and a direction parallel to a bottom surface of the spraying module ranges from 0 to 90 degrees.

6. The cleaning machine according to claim 4, wherein:
the spraying module is disposed on the second cleaning device; and
a spraying direction of the spraying module contains a swing path of the second cleaning device.

7. The cleaning machine according to claim 4, wherein
at least one portion of a spraying period of the spraying module overlaps with a swing period of the second cleaning device.

8. The cleaning machine according to claim 4, wherein the spraying module is disposed on one end of the cleaning machine.

9. The cleaning machine according to claim 4, wherein:
the spraying module comprises a column, and the liquid drainage port is disposed on the column and exposed from the housing;
the housing is defined by a long-axis direction of the housing and a short-axis direction of the housing perpendicular to the long-axis direction of the housing; and
an angle between a long-axis direction of the column of the column and the short-axis direction of the housing ranges from 0 to 90 degrees.

10. The cleaning machine according to claim 4, wherein the liquid pumping unit comprises an ultrasonic vibrating piece, and the liquid drainage port is disposed on the ultrasonic vibrating piece.

11. The cleaning machine according to claim 4, wherein the spraying module further comprises:
a liquid inlet port disposed on the liquid tank; and
a cover configured to cover the liquid inlet port, wherein the cover is formed with a separation part.

12. The cleaning machine according to claim 11, wherein:
the liquid tank defines a storage space and a pressure relief hole, and the liquid inlet port is disposed on the liquid tank;
the storage space stores the liquid;
the liquid inlet port communicates with the storage space;
a protrusion of the cover can be plugged into the liquid inlet port to prevent the liquid from leaking out; and
the pressure relief hole communicates with the storage space, wherein in a process when the protrusion of the cover is plugged into the liquid inlet port, the storage space communicates with an external environment through the pressure relief hole, wherein after the cover has been completely installed, the pressure relief hole is covered by the cover to prevent the liquid from leaking out of the pressure relief hole.

13. The cleaning machine according to claim 2, further comprising a compressor module, wherein:
the first cleaning device and the plate member define a first space,
the second cleaning device and the plate member define a second space,
the compressor module is communicated with the first space and the second space and pumps air from the first space and the second space, so that each of the first space and the second space forms a negative pressure, and the cleaning machine is sucked onto the plate member.

14. The cleaning machine according to claim 2, wherein the connection device is a machine base.
